(19) United States
(12) Patent Application Publication
(10) Pub. No.: US 2005/0087153 A1
(43) Pub. Date: Apr. 28, 2005

(54) Piston for an internal combustion engine

(76) Inventor: Kil Min Moon, Suwon-city (KR)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/747,897

(22) Filed: Dec. 29, 2003

(30) Foreign Application Priority Data
Oct. 24, 2003 (KR) 10-2003-0074757

(51) Int. Cl. F01P 1/04; F02F 1/00

(52) U.S. Cl. 123/41.35; 123/193.6

(57) ABSTRACT

For enhancement of heat dissipation from a piston of an internal combustion engine, an airtight cavity vertically elongated in a piston body is partially filled with a heat transfer material.

### CROSS-REFERENCE TO RELATED APPLICATIONS

This application claims priority of Korean Application No. 10-2003-0074757, filed on Oct. 24, 2003, the disclosure of which is incorporated fully herein by reference.

### FIELD OF THE INVENTION

Generally, the present invention relates to a piston for an internal combustion engine. More particularly, the present invention relates to a piston for an internal combustion engine with enhanced heat dissipation during operation of the internal combustion engine.

### BACKGROUND OF THE INVENTION

An internal combustion engine produces power by burning fuel in the engine. A piston is disposed in such an internal combustion engine and reciprocally moves under a combustion pressure of the fuel.

Since the piston is exposed to very high temperatures, efficient dissipation of heat from the piston plays an important role in durability and performance of the engine.

The piston is exposed to highest temperature at its upper portion, i.e., a head portion thereof. Frequently, a piston has a sunken portion on its head (called a concave portion hereinafter). A concaved piston head has a larger surface area exposed to combustion heat, and therefore, the heat dissipation characteristic of the piston becomes more important in determining the durability and performance of the engine.

The information disclosed in this Background of the Invention section is only for enhancement of understanding of the background of the invention and should not be taken as an acknowledgement or any form of suggestion that this information forms the prior art that is already known in this country to a person of ordinary skill in the art.

### SUMMARY OF THE INVENTION

The motivation for the present invention is to provide a piston for an internal combustion engine having enhanced heat dissipation capabilities.

An exemplary piston for an internal combustion engine according to an embodiment of the present invention includes a piston body having an airtight cavity vertically elongated therein, and a heat transferring material partially filling the airtight cavity.

In a further embodiment, the heat transferring material is a fluid.

In a yet further embodiment, thermal conductivity of the fluid lies in the range of 0.1 to 200 W/m-K.

In another further embodiment, density of the fluid lies in the range of 500 to 30,000 Kg/m³.

In another further embodiment, heat capacity of the fluid lies in a heat capacity range of from 0.1 to 10 KJ/KgK.

In another further embodiment, the fluid satisfies a plurality of criteria such as a thermal conductivity criterion, a density criterion, and/or a heat capacity criterion.

Such fluid conditions can be satisfied by including at least one material among mercury, potassium, sodium, a sodium-potassium compound, and a bismuth-lead compound.

In another further embodiment, the piston body comprises a ring mounting groove for mounting a piston ring, and an upper end of the cavity is elongated above the mounting groove.

In another further embodiment, the piston body comprises a concave portion formed on a head surface thereof, and an upper end of the cavity is elongated above a bottom of the concave portion.

In another further embodiment, the piston body comprises a boss portion for mounting a piston pin, and a lower end of the cavity is elongated below the boss portion.

In another further embodiment, the heat transferring material fills less than 50% of the volume of the airtight cavity. In this case, the heat transferring material may fill about 20% of the volume of the airtight cavity.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 is a sectional view of a piston for an internal combustion engine according to an embodiment of the present invention, showing a state in which the piston is stationary or moving upward; and

FIG. 2 is a sectional view of a piston for an internal combustion engine according to an embodiment of the present invention, showing a state in which the piston is moving downward.

### DETAILED DESCRIPTION OF THE PREFERRED EMBODIMENTS

An embodiment of the present invention will hereinafter be described in detail with reference to the accompanying drawings.

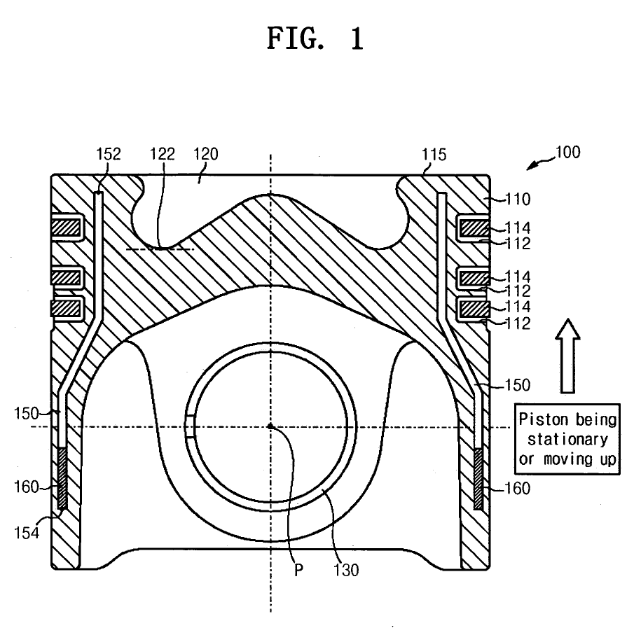

FIG. 1 is a sectional view of a piston for an internal combustion engine according to an embodiment of the present invention, showing a state in which the piston is stationary or moving upward.

As shown in FIG. 1, a piston 100 for an internal combustion engine according to an embodiment of the present invention includes a piston body 110 having an airtight cavity 150 vertically elongated in the piston body 110, and a heat transferring material 160 that partially fills the airtight cavity 150.

According to an embodiment of the present invention, the heat transferring material 160 is a fluid. This does not necessarily mean that the heat transferring material 160 should be a fluid at a normal temperature (i.e., temperature of ambient air). A desired heat dissipation effect can be met if the heat transferring material 160 is a fluid above about 250° C., which is a normal operation temperature of the piston 100.

As shown in FIG. 1, the piston body 110 includes ring mounting grooves 112 for mounting piston rings 114. An upper end 152 of the cavity 150 is elongated above the mounting grooves 112. FIG. 1 shows that the cavity 150 is elongated above an uppermost mounting groove among the mounting grooves 112, but it should not be understood that the scope of the present invention is limited thereto. An embodiment of the present invention may be varied such that the cavity 150 is elongated at least above a lowermost mounting groove among the mounting grooves 112.

In addition, according to an embodiment of the present invention, the piston body 110 includes a concave portion 120 formed on a head surface 115 of the piston body 110. The upper end 152 of the cavity 150 is elongated above a bottom 122 of the concave portion 120.

In addition, the piston body 110 includes a boss portion 130 for mounting a piston pin. A lower end 154 of the cavity 150 is elongated below the boss portion 130.

In summary, by elongating the cavity 150 as high as possible and as low as possible, the heat dissipation effect by the heat transferring material 160 can be maximized.

When the piston 100 moves up and down, the heat transfer fluid 160 moves up and down in the airtight cavity 150, thereby transferring heat from an upper portion of the piston 100 to its lower portion. For this reason, the heat transferring material 160 only partially fills the airtight cavity 150.

For enhancing heat transfer effect by movement of the heat transfer fluid 160, the heat transfer fluid 160 preferably fills less than 50% of the volume of the airtight cavity 150. According to an embodiment of the present invention, the heat transfer fluid 160 fills about 20% of the volume of the airtight cavity 150.

As shown in FIG. 1, the fluid 160 is forced to the bottom side of the cavity 150 when the piston 100 is stationary or moves upward.

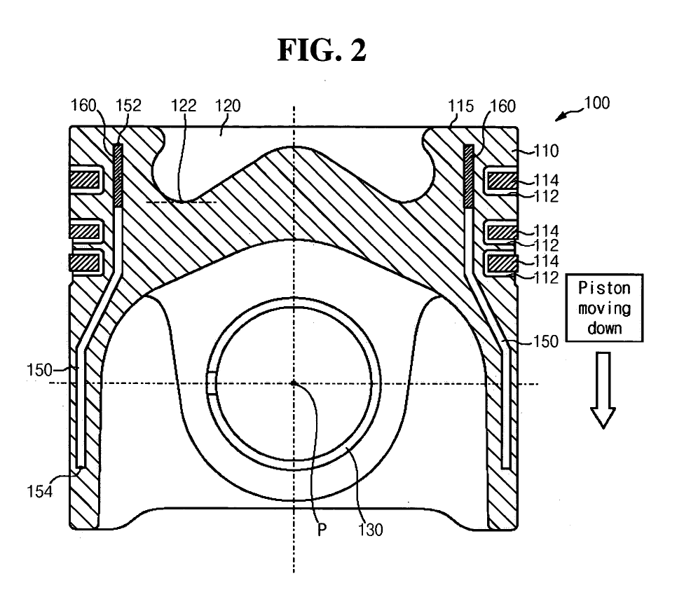

To the contrary, FIG. 2 shows the location of the fluid 160 in the cavity 150 when the piston moves downward. As shown in FIG. 2, when the piston 100 moves down, the fluid 160 moves upward within the cavity 150 of the piston 100 by the inertia of fluid 160. While at the upper end 152 of the cavity 150, the fluid 160 absorbs heat from the head portion of the piston 100.

When the piston 100 moves up again, the fluid 160 moves to the bottom of the cavity 150 as shown in FIG. 1, and the fluid 160 transfers its heat to the lower portion of the piston 100.

In consideration of such a heat dissipation mechanism, preferred conditions for the fluid 160 for optimal heat transfer may be set as follows.

For allowing rapid movement of the fluid 160 relative the piston 100, it is preferable that the fluid 160 has a high density. In this sense, a preferred density of the fluid 160 has been found to be in a range of 500 to 30,000 Kg/m³.

In addition, for optimal absorption of heat at the upper portion of piston 100 and quick transfer of heat at the lower portion thereof, it is preferable that the fluid 160 has high thermal conductivity. In this sense, a preferable thermal conductivity for the fluid 160 has been found to be in a range of 0.1 to 200 W/m-K.

In addition, it is preferred that the fluid 160 be rapidly heated and cooled. In this sense, a preferred heat capacity of the fluid 160 has been found to be a in a range of 0.1 to 10 KJ/Kg-K.

It is preferred that the fluid 160 satisfy a plurality of the above described conditions regarding thermal conductivity, density, and heat capacity, and more preferably, all the conditions.

Exemplary fluids that meet such conditions include mercury, potassium, sodium, a sodium-potassium compound, and a bismuth-lead compound.

The heat transfer fluid 160 is not limited to only one of the exemplary fluids. The above materials may be mixed, or additional ingredients may be added to a pure one or a mixture without detriment to the heat dissipation characteristic of the piston 100. For example, the heat transfer fluid 160 may be formed by mixing equal amounts of mercury, potassium, sodium, a sodium-potassium compound, and a bismuth-lead compound.

According to an embodiment of the present invention, heat is rapidly transferred from an upper portion of a piston to a lower portion thereof, enhancing durability of a piston and an engine.

By using a fluid as a heat transferring material, heat transfer can be enhanced. By imposing a thermal conductivity criterion, a density criterion, and/or a heat capacity criterion to the fluid, performance of the fluid may be optimized.

By elongating a cavity containing the heat transfer fluid as high as possible and as low as possible, heat dissipation may be maximized.

The heat dissipation may be further enhanced by filling the cavity with the heat transfer fluid to less than 50% of the volume of the cavity, and more specifically to about 20% of the volume thereof.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

1. A piston for an internal combustion engine, comprising:
a piston body having an airtight cavity vertically elongated therein; and
a heat transfer material partially filling the airtight cavity.

2. The piston of claim 1, wherein the heat transferring material is a fluid.

3. The piston of claim 2, wherein the fluid satisfies a thermal conductivity criterion, the thermal conductivity criterion being that a thermal conductivity of the fluid is in a conductivity range of 0.1 to 200 W/m-K.

4. The piston of claim 2, wherein the fluid satisfies a density criterion, the density criterion being that the density of the fluid is in the range of 500 to 30,000 Kg/m³.

5. The piston of claim 2, wherein the fluid satisfies a heat capacity criterion, the heat capacity condition being that a heat capacity of the fluid is in a heat capacity range of from 0.1 to 10 KJ/KgK.

6. The piston of claim 2, wherein the fluid satisfies a plurality of criteria among a thermal conductivity criterion, a density criterion, and a heat capacity criterion, wherein:
the thermal conductivity criterion is that thermal conductivity of the fluid is in the range of 0.1 to 200 W/m-K;
the density criterion is that the density of the fluid is in the range of 500 to 30,000 Kg/m³; and
the heat capacity criterion is that heat capacity of the fluid is in the range of 0.1 to 10 KJ/Kg-K.

7. The piston of claim 6, wherein the fluid comprises at least one material among mercury, potassium, sodium, a sodium-potassium compound, and a bismuth-lead compound.

8. The piston of claim 1, wherein:
the piston body comprises a ring mounting groove for mounting a piston ring; and
an upper end of the cavity is elongated above the mounting groove.

9. The piston of claim 1, wherein:
the piston body comprises a concave portion formed on a head surface thereof; and
an upper end of the cavity is elongated above a bottom of the concave portion.

10. The piston of claim 1, wherein:
the piston body comprises a boss portion for mounting a piston pin; and
a lower end of the cavity is elongated below the boss portion.

11. The piston of claim 8, wherein:
the piston body comprises a boss portion for mounting a piston pin; and
a lower end of the cavity is elongated below the boss portion.

12. The piston of claim 9, wherein
the piston body comprises a boss portion for mounting a piston pin; and a lower end of the cavity is elongated below the boss portion.

13. The piston of claim 1, wherein the heat transfer material fills less than 50% of the volume of the airtight cavity.

14. The piston of claim 13, wherein the heat transfer material fills about 20% of the volume of the airtight cavity.
